(19) United States
(12) Patent Application Publication
(10) Pub. No.: US 2018/0315177 A1
(43) Pub. Date: Nov. 1, 2018

(54) Plant disease photo identifier and treatment

(71) Applicant: Hany Elzind, Sparta, NJ (US)

(72) Inventor: Hany Elzind, Sparta, NJ (US)

(21) Appl. No.: 15/731,168

(22) Filed: Apr. 27, 2017

(51) Int. Cl. G06T 7/00; G06F 17/30

(52) U.S. Cl. CPC G06T 7/0002; G06T 2207/10024; G06F 17/30908

(57) ABSTRACT

This invention discloses a method to recognize and identify plant disease by analysing a plant disease image details taken by an image capturing device and comparing it to the images of plant diseases in database established in the image capturing device to identify the disease or the unhealthy condition using an image recognition technology.

The application will recommend treatment information, products, insecticides and other preventive and cure tips related to this disease, infection or unhealthy condition.

the disease specific treatment recommendations, preventive and cure tips are linked to the disease recognized via the recognition module established in the image capturing device. The image capturing device is mobile smart phone or Ipad or electronic tablet with display screen. Using this application method the user is able to know the plant disease, how to treat it and the name of the product to use for treatment and cure tips just by pressing the application icon and taking a picture for the plant disease area.

Plant disease photo identifier and treatment software application is a new application that identifies a plant disease and recommend treatment products and insecticides. It also explains disease features, how to cure and prevent the disease.

The principal of operation is to install the application in a photo capturing device with a display, The photo capturing device is a mobile smart phone, Ipad or electronic tablet. The application has a database of plant disease images stored in the photo capturing device or outside retrievable storage like cloud or external drive. The application has also a software program linking each disease to treatment information and products of this specific disease and also cure and preventive tips to keep the plant healthy.

The program displayer the name of the disease, cure, treatment products and treatment procedures and tips on the display of the photo capturing device.

The application identifies the plant disease by comparing and matching the picture taken by the photo capturing device to the part of the plant that has the disease, infection or the unhealthy condition to the images of the diseases in the database and analysing the characteristics of the disease using pixel image analysis and image recognition technology.

The application is to be installed in the photo capturing device from the app store or play store then an icon will appear for a doctor treating a plant on the display of the photo capturing device.

The use of the application is by pressing on the app icon in the photo capturing device display that will activate the camera.

then taking a picture of the part of the plant that has the disease or the unhealthy condition by the camera of the photo capturing device.

the application will show the name of the disease, treatment products and procedures, cure and disease preventive tips on the display of the photo capturing device.

### BRIEF DESCRIPTION OF DRAWINGS

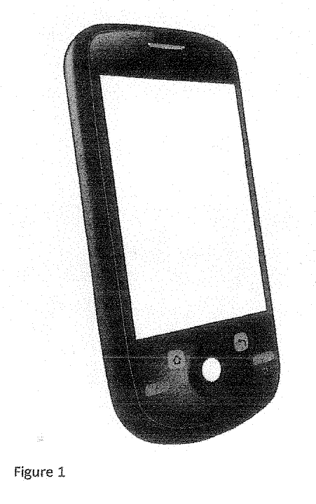

1. FIG. 1, picture capturing device with display that has an identification, recognizing and treatment recommendations application installed. The application identify the plant disease by comparing the picture of the plant disease taken to the images of plant diseases in the database.

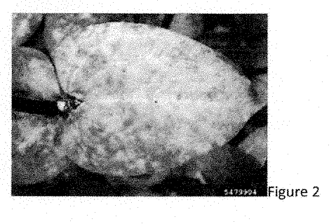

2. FIG. 2, A plant or a tree that has the disease or the unhealthy condition. (object to be photographed).

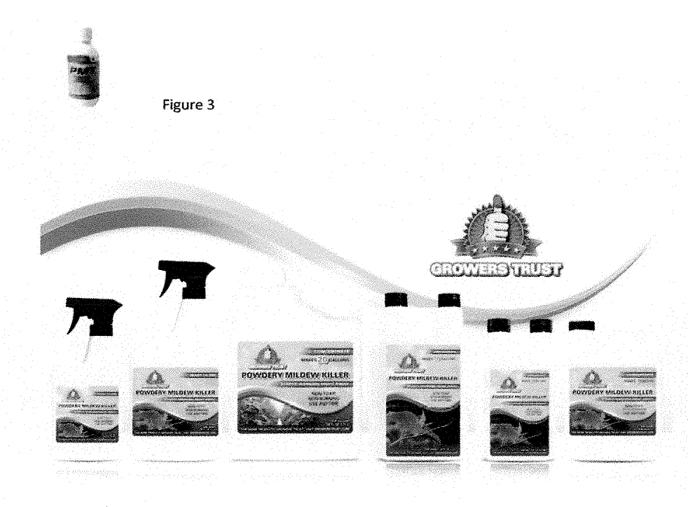

3. FIG. 3, The name of the disease, treatment procedure, treatment products, cure and preventive recommendations for this specific disease will be displayed on the display screen of the image capturing device display.

What is claimed is:

1. A method of identifying plant disease by analysing the image taken by an image capturing device for the part containing the plant disease.
According to claim 1 the method to identify the plant disease is a software database application that has database for images of plant diseases installed in an image capturing device that has display screen or stored in retrievable cloud storage or retrievable external storage. Recognizing and identifying the plant disease image taken by the image capturing device for the part of the plant that has the disease and comparing it to the images of plant diseases in the data base to identify the plant disease. The identification is processed by pixel image analysis and recognition of the plant disease characteristics using image recognition technology. according to claim 1 there is one or more images corresponding to each plant disease to be matched and compared to the plant disease picture taken by the the picture capturing device to identify and recognize the plant disease.
according to claim 1 the application is installed from play store or from the app store, together with the software program and images database.
An icon of a doctor treating a plant will be displayed on the photo capturing device display screen. by touching the icon the camera is activated and taking a picture will identify the plant disease and the treatment, cure tips and treatment procedures.

2. The plant disease name identified by the application will be displayed on the image capturing device display.
according to claim 2, image capturing device is smart cell phone, Ipad or electronic tablet with display screen.

3. The disease name identified is linked to the disease features, information, treatment products, treatment tips, treatment procedures,
insecticides, health and preventive information to cure the plant disease and prevent it.
according to claim 3 the plant disease name, information, treatment and treatment products will be displayed on the image capturing device display screen.
